(19) United States
(12) Patent Application Publication
(10) Pub. No.: US 2013/0086371 A1
(43) Pub. Date: Apr. 4, 2013

(54) METHOD FOR DEVICE-LESS OPTION-ROM BIOS LOAD AND EXECUTION

(71) Applicants: Pradeep Bisht, Mountain View, CA (US); Kashif Memon, Sunnyvale, CA (US)

(72) Inventors: Pradeep Bisht, Mountain View, CA (US); Kashif Memon, Sunnyvale, CA (US)

(21) Appl. No.: 13/251,025

(22) Filed: Sep. 30, 2011

(51) Int. Cl. G06F 9/24

(52) U.S. Cl. 713/2

(57) ABSTRACT

An invention is provided for loading an Option-ROM BIOS into memory without the need of an associated hardware device, such as a PCI card. The invention includes loading code from a boot sector of a designated boot device into memory, wherein the code includes Option-ROM location data denoting a location of an Option-ROM BIOS. The Option-ROM BIOS then is loaded into memory utilizing the Option-ROM location data. As above, the Option-ROM BIOS includes MBR location data denoting a location of the MBR associated with the OS. Thus, the MBR can be loaded into memory utilizing the MBR location data in the Option-ROM BIOS and control can be transferred to the MBR. Thereafter, the OS system files are loaded into memory utilizing the MBR.

### BACKGROUND OF THE INVENTION

1. Field of the Invention

This invention relates generally to Option-Rom BIOS loading and execution, and more particularly to loading and executing an Option-Rom BIOS without a PCI device.

2. Description of the Related Art

An Option-Rom BIOS is firmware often located on a ROM of a Peripheral Component Interconnect (PCI) device card, which is called by the system BIOS during system startup. The purpose of an Option-ROM generally is to access the related PCI device and its child devices during the pre-OS environment. A video BIOS is an example of an Option-ROM that is located on a video card and is loaded and executed to allow access to the video card. However, as explained in greater detail subsequently, an Option-ROM requires a hardware device card to be present in the system.

Option-ROMs typically are initialized after power-on self-tests (POST) checks are completed, thus giving them a chance to intercept system interrupts in order to provide increased functionality to the system. For example, INT 13H is responsible for providing disk services. A disk controller card may include an Option-ROM BIOS that, once loaded and executed, intercepts calls to INT 13H and allows the disk controller card Option-ROM BIOS to insert details regarding the disks associated with the card.

FIG. 1 is a block diagram showing a prior art computer system 100 illustrating system startup during the pre-OS environment. The computer system 100 includes a central processing unit (CPU) 102 connected to system memory 104. The CPU 102 also is connected to a plurality of PCI device cards 106a and 106b. Each PCI device card 106a and 106b stores an Option-ROM 110a, 110b in the on-board memory of the PCI device card 106a, 106b. Once loaded into system memory, the Option-ROM 110a, 110b of each PCI device card 106a, 106b provides the CPU 102 access to specific hardware devices such as video or hard disks 108 associated with the card.

At system startup, during the pre-OS environment, the system BIOS scans for the presence of hardware devices and loads the Option-ROMs 110a, 110b from detected PCI device cards 106a, 106b into system memory 104. Each Option-ROM 110a, 110b is proprietary to the associated PCI device card 106a, 106b and is utilized to access the related PCI device and its child devices. For example, in FIG. 1 the Option-ROM 110a functions to provide access to the video PCI device card 106a, which controls an associated monitor, while Option-ROM 110b functions to provide access to the disk controller PCI device card 106b, which provides access to the associated disk 108. Once the Option-ROMs are loaded into system memory 104, the operating system files 112 stored on disk 108 are loaded into system memory 104.

As illustrated in FIG. 1, a hardware device card is required in order to allow the system BIOS to detect and load the Option-ROM BIOS into system memory 104 in the pre-OS environment. Specifically, when a computer system boots the system BIOS detects that a card is connect then loads the associated Option-ROM code from the card into system memory and executes that code. Unfortunately, in the prior art, if there is no associated hardware, such as a PCI device card, installed in the computer system, there is no way to load an Option-ROM BIOS into system memory during the pre-OS environment.

In view of the foregoing, there is a need for systems and methods for loading and executing an Option-ROM BIOS into system memory without the use of an associated hardware device card. Ideally, the systems and methods should not require an associated hardware device card to be installed into the computer system. Moreover, the systems and methods should allow the Option-ROM BIOS to be loaded into system memory in the pre-OS environment, that is, prior to loading the operating system.

### SUMMARY OF THE INVENTION

Broadly speaking, embodiments of the present invention address these needs by providing a method for loading an Option-ROM BIOS into system memory without the need of an associated hardware device, such as a PCI card. In one embodiment, the method for loading an Option-ROM BIOS into memory includes loading code from a boot sector of a designated boot device into memory. Among other data, the code includes Option-ROM location data denoting a location (i.e., address) of an Option-ROM BIOS that is to be loaded into memory without the use of an associated hardware device. The Option-ROM BIOS then is loaded into memory utilizing the Option-ROM location data. The Option-ROM BIOS includes MBR location data denoting a location of the master boot record (MBR) associated with the operating system. Once loaded into memory, the Option-ROM BIOS can be utilized to filter input/output (IO) data during the pre-OS environment. For example, the Option-ROM BIOS can be used to redirect selected file requests to a storage device other than the designated boot device during the pre-OS environment.

A further method for loading an Option-ROM BIOS into memory is disclosed in an additional embodiment of the present invention. As above, the method includes loading code from a boot sector of a designated boot device into memory, wherein the code includes Option-ROM location data denoting a location of an Option-ROM BIOS. The Option-ROM BIOS then is loaded into memory utilizing the Option-ROM location data. As above, the Option-ROM BIOS includes MBR location data denoting a location of the MBR associated with the OS. The MBR then is loaded into memory utilizing the MBR location data in the Option-ROM BIOS and control is transferred to the MBR. Thereafter, the OS system files are loaded into memory utilizing the MBR. Initially, to set up a system to operate utilizing this embodiment, an existing MBR can be copied to a new location on the designated boot device, and the code can be stored at the previous location of the MBR. Then, the Option-ROM BIOS can be updated to include the MBR location data denoting the new location of the MBR on the designated boot device.

In yet a further embodiment of the present invention, a computer program embodied on a computer readable medium for programming a computer to load an Option-ROM BIOS into memory is disclosed. The computer program includes a code segment for copying an existing MBR to a new location on the designated boot device and a code segment for storing an Option-ROM BIOS on the designated boot device. The Option-ROM BIOS includes MBR location data denoting a location of the MBR. For example, on PC based systems, the machine code can be stored at sector 0 of the designated boot device. Further, a code segment is included for storing machine code at the previous location of the MBR on the designated boot device. The machine code includes Option-ROM location data denoting the location of the Option-ROM BIOS. Then, after the machine code is loaded from the boot sector of a designated boot device into memory during system startup, the Option-ROM BIOS is loaded into memory utilizing the Option-ROM location data stored in the machine code. After loading the Option-ROM BIOS during startup, the MBR is loaded into memory utilizing the MBR location stored in the Option-ROM BIOS and thereafter the OS system files can be loaded into memory utilizing the MBR.

In this manner, embodiments of the present invention allow an Option-ROM BIOS to be loaded into system memory in a device-less manner, without the need of an associated hardware device such as a PCI card. Because the device-less Option-ROM BIOS is not associated with any particular hardware device, the device-less Option-ROM BIOS can interface with and handle multiple installed hardware devices. For example, the device-less Option-ROM BIOS of the embodiments of the present invention can interface, handle and filter the IO for any disk or device card associated with the computer system. As such, the device-less Option-ROM BIOS can facilitate disk caching in the pre-OS environment, filtering IO to redirect specific request to a cache disk other than the designated boot device, thus allowing operating system files to be loaded from different disks. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is a block diagram showing a prior art computer system illustrating system startup during the pre-OS environment;

FIG. 2 is a block diagram showing an exemplary computer system having device-less Option-ROM BIOS loading and execution ability, in accordance with an embodiment of the present invention;

FIG. 3 is a diagram showing the exemplary designated boot device, having a device-less ROM boot record (DRBR) for facilitating device-less Option-ROM BIOS loading and execution, in accordance with an embodiment of the present invention;

FIG. 4 is a block diagram showing the exemplary computer system after loading the device-less Option-ROM BIOS into system memory, in accordance with an embodiment of the present invention;

FIG. 5 is a block diagram showing the exemplary computer system after loading the MBR into system memory, in accordance with an embodiment of the present invention;

FIG. 6 is a block diagram showing the exemplary computer system after loading the OS files into system memory, in accordance with an embodiment of the present invention; and

FIG. 7 is a flowchart showing a method for loading an Option-ROM BIOS into memory without the need of an associated hardware device, such as a PCI card.

### DETAILED DESCRIPTION OF THE PREFERRED EMBODIMENTS

An invention is disclosed for loading an Option-ROM BIOS into system memory without the need of an associated hardware device, such as a PCI card. In general, Embodiments of the present invention utilize the boot sector of a disk to provide a mechanism for loading an Option-ROM BIOS into system memory prior to loading the operating system. Because the system BIOS attempts to load the operating system via the boot sector, this procedure provides a mechanism to load an Option-ROM BIOS into system memory without requiring additional hardware or physically altering the system architecture.

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

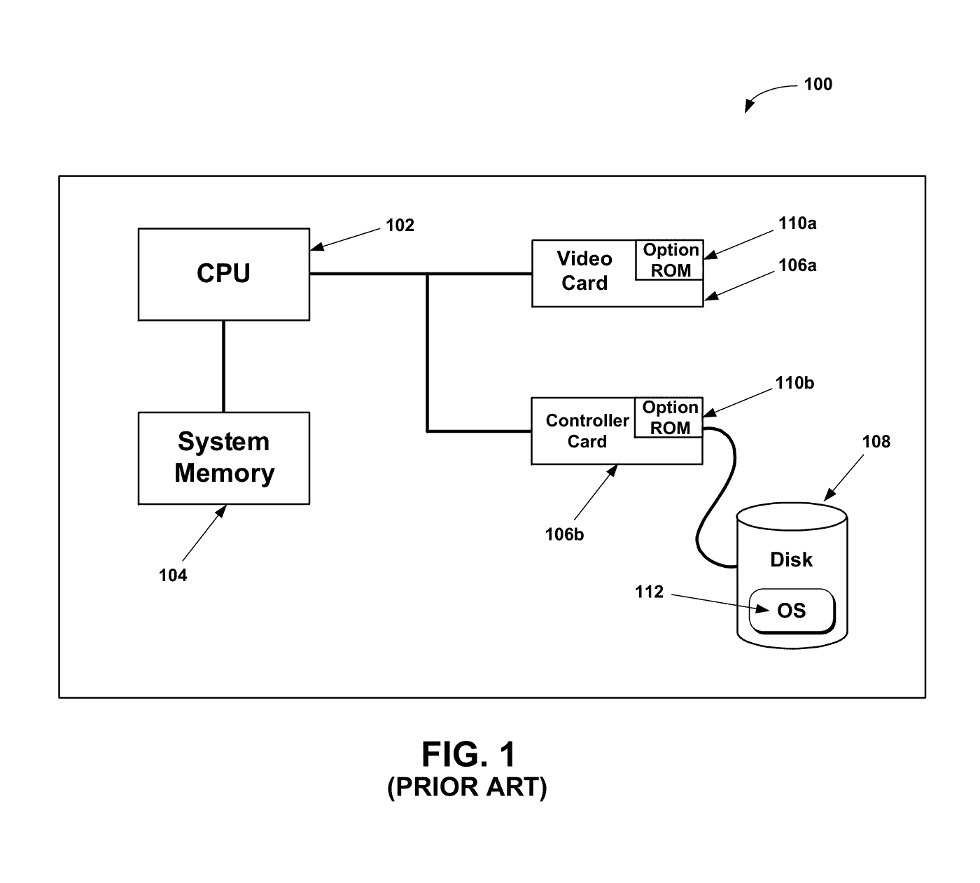

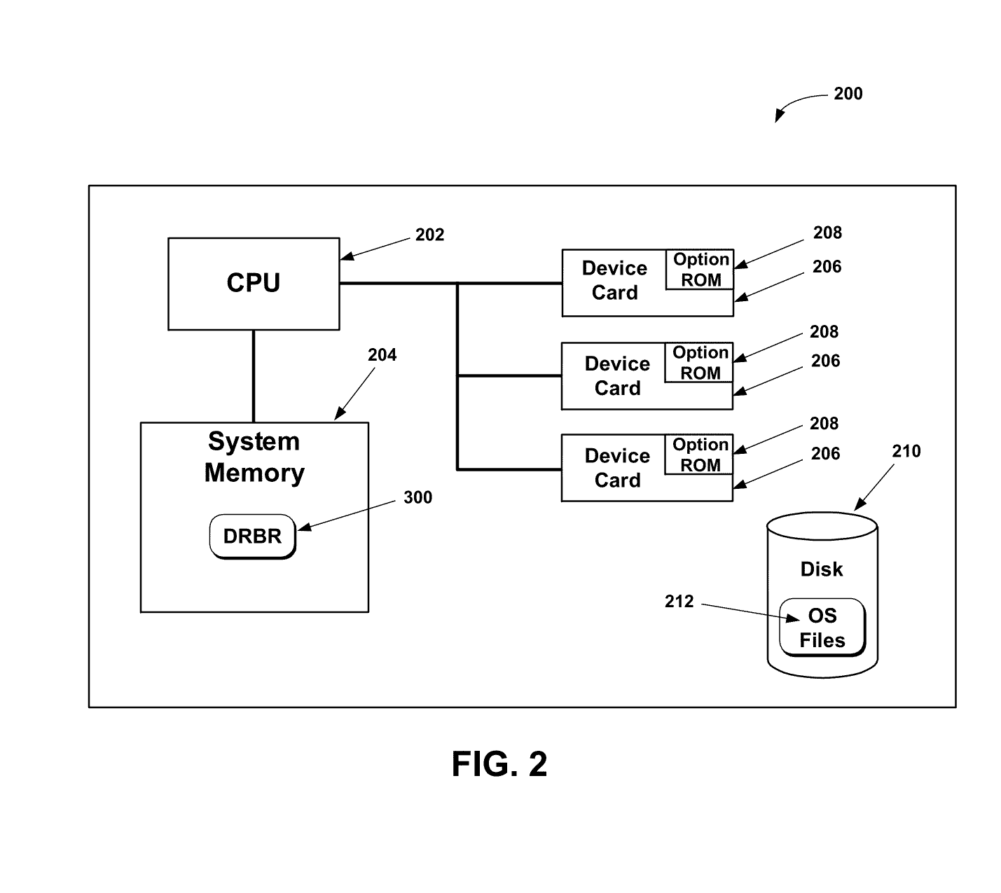

FIG. 1 was described in terms of the prior art. FIG. 2 is a block diagram showing an exemplary computer system 200 having device-less Option-ROM BIOS loading and execution ability, in accordance with an embodiment of the present invention. The computer system 200 includes a central processing unit (CPU) 202 connected to system memory 204 and a plurality of device cards 206. Each device card 206 can include an Option-ROM BIOS 208 stored in the ROM/flash memory present on each device card 206. Further included in the computer system 200 is one or more storage disks 210, which stores operating system files 212 for controlling the computer system 200 after startup.

In general, the first code executed by the CPU 202 during system startup is the system BIOS, which sets up the hardware for the computer system 200 and loads the operating system. To do this, the system BIOS scans the computer system 200 for hardware, such as the device cards 206, and loads the Option-ROM BIOS 208 for each device card 206. In this manner, each loaded and executed Option-ROM BIOS 208 provides access to the related device card 206 and its child devices during the pre-OS environment.

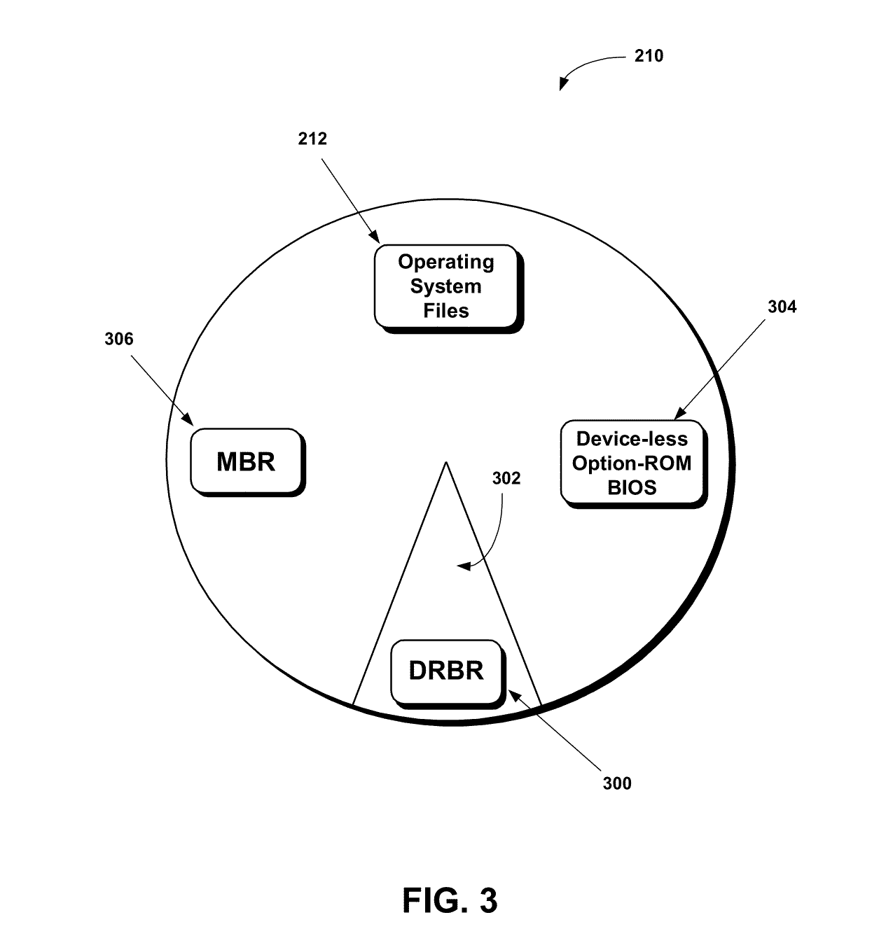

The system BIOS then identifies a designated boot device, such as the disk 210 and attempts to load the operating system (OS) software that further controls the computer system 200. In prior art computer systems, the system BIOS loaded the master boot record (MBR) from the boot sector of the designated boot device to facilitate loading the operating system. The MBR generally was stored in sector 0 of the designated boot device, and consisted of machine code that once executed facilitated loading and execution of the OS files, before transferring control to the OS. However, embodiments of the present invention replace the MBR with a device-less ROM boot record (DRBR) to facilitate loading of a device-less Option-ROM, as discussed in greater detail next with reference to FIG. 3.

FIG. 3 is a diagram showing the exemplary designated boot device 210, having a device-less ROM boot record (DRBR) 300 for facilitating device-less Option-ROM BIOS loading and execution, in accordance with an embodiment of the present invention. The designated boot device 210 includes a DRBR 300 located in the boot sector 302 of the designated boot device 210. In addition, a device-less Option-ROM BIOS 304 is stored on the designated boot device 210, as well as a master boot record (MBR) 306, and the operating system files 212. Although FIG. 3 shows both the device-less Option-ROM BIOS 304 and MBR 306 stored on the designated boot device 210, it should be noted that either the device-less Option-ROM BIOS 304, the MBR 306 or both can be stored on an alternate storage device, such as a cache disk device.

As mentioned above, after loading the Option-ROM BIOS code from hardware installed on the computer system during startup, the system BIOS loads code from the boot sector 302 (e.g., sector 0). However, embodiments of the present invention replace the MBR 306 normally stored at the boot sector 302 with the DRBR 300 to facilitate loading of a device-less Option-ROM 304. Thus, during startup in the embodiment of FIG. 3, the system BIOS loads the DRBR 300 from the boot sector 302 (e.g., sector 0) into system memory.

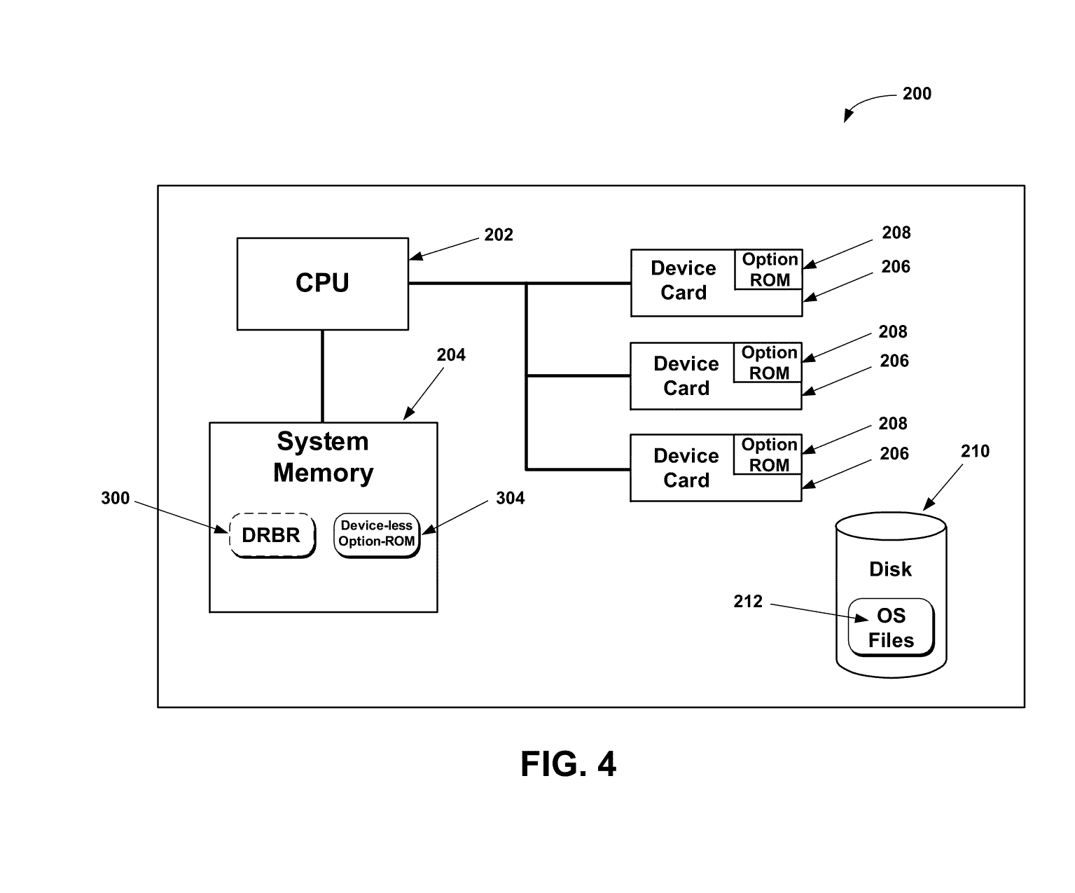

Referring to FIGS. 2 and 3, after loading the Option-ROM BIOS code 208 from hardware 206 installed on the computer system 200, the system BIOS loads the DRBR 300 from the boot sector of the designated boot device 210 into system memory 204. The DRBR 300 includes data, such as a pointer, identifying the location of the device-less Option-ROM BIOS 304 stored on the designated boot device 210 or other storage device. Once the DRBR 300 code is loaded from the boot sector 302 into system memory 204, the DRBR 300 functions to load the device-less Option-ROM BIOS 304 into system memory 204 as illustrated in FIG. 4.

FIG. 4 is a block diagram showing the exemplary computer system 200 after loading the device-less Option-ROM BIOS 304 into system memory 204, in accordance with an embodiment of the present invention. In FIG. 4, the computer system 200 includes the CPU 202 connected to a plurality of device cards 206, each including an Option-ROM BIOS 208.

In addition, both the DRBR 300 and the device-less Option-ROM BIOS 304 have been loaded into system memory 204.

Once the device-less Option-ROM BIOS 304 is loaded into system memory 204, the DRBR 300 transfers control to it. In this manner, the device-less Option-ROM BIOS 304 is now free to operate as if it was loaded into memory from a PCI device. In one embodiment, the device-less Option-ROM BIOS 304 can be utilized to filter pre-OS input/output (IO). Along these lines, when the OS is being loaded, the device-less Option-ROM BIOS 304 of the embodiments of the invention can intercept selected portions of the IO and serve the data from another device.

Moreover, because the device-less Option-ROM BIOS 304 is not associated with any particular hardware device, the device-less Option-ROM BIOS 304 can interface with and handle multiple installed hardware devices. Normal Option-ROMs 208 could only interface with and handle the associated device card 206 and the child devices of the device card 206. For example, the Option-ROM BIOS for a device card 206 that has two disks connected to it could only control those two disks or the controller card. In contrast, the device-less Option-ROM BIOS 304 of the embodiments of the present invention is not associated with any device card 206. As such, device-less Option-ROM BIOS 304 can interface, handle and filter the IO for any disk or device card 206 associated with the computer system 200.

In this manner, the device-less Option-ROM BIOS 304 can facilitate disk caching in the pre-OS environment, before the operating system is loaded into system memory. Because the device-less Option-ROM BIOS 304 is loaded and executed prior to loading the OS, the device-less Option-ROM BIOS 304 can filter the IO associated with loading the OS into system memory 204. Thus, the device-less Option-ROM BIOS 304 can intercept various IO requests and redirect specific request to a cache disk other than the designated boot device, allowing operating system files to be loaded from different disks.

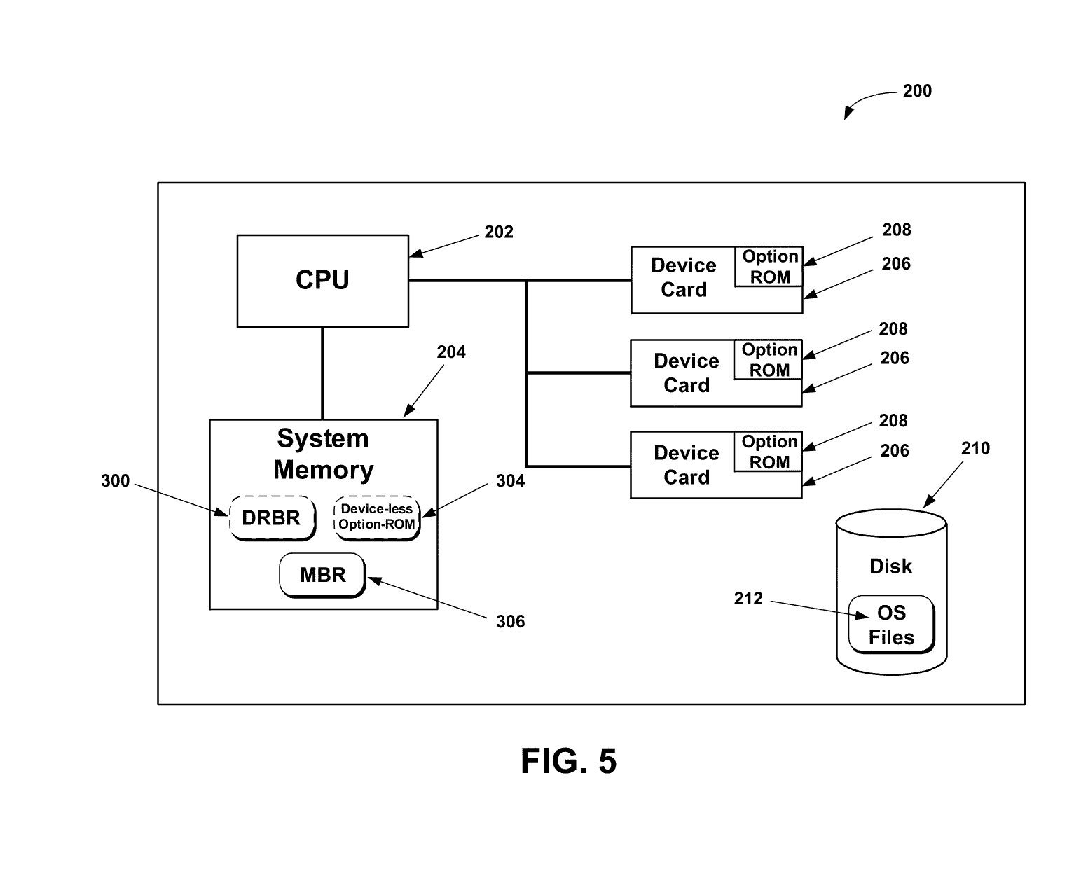

Next, the process for loading the OS can begin. The device-less Option-ROM BIOS 304 further includes data, such as a pointer, identifying the location of the MBR 306 stored on the designated boot device 210 or on an alternate storage device (e.g., cache disk device). Once the device-less Option-ROM BIOS 304 code has completed setting itself up and initializing, the device-less Option-ROM BIOS 304 loads the MBR 306 into system memory 204, as illustrated in FIG. 5.

FIG. 5 is a block diagram showing the exemplary computer system 200 after loading the MBR 306 into system memory 204, in accordance with an embodiment of the present invention. As illustrated in FIG. 5, the computer system 200 includes the CPU 202 connected to a plurality of device cards 206, each including an Option-ROM BIOS 208. In addition, the DRBR 300, the device-less Option-ROM BIOS 304, and MBR 306 each have been loaded into system memory 204.

The MBR 306 generally includes machine code that once executed facilitates loading and execution of the operating system files, before transferring control to the OS. In one embodiment, the MBR 306 can be similar to the master boot record of conventional computer systems. However, the MBR 306 of the present invention is not stored in the boot sector (e.g., sector 0) of the designated boot device 210. In embodiments of the present invention, the device-less Option-ROM BIOS 304 loads the MBR 306 into system memory 204 from a location other than the boot sector and transfers control to it. Once the MBR 306 is loaded and executed, the boot sequence can continue in much the same manner as in conventional computer systems.

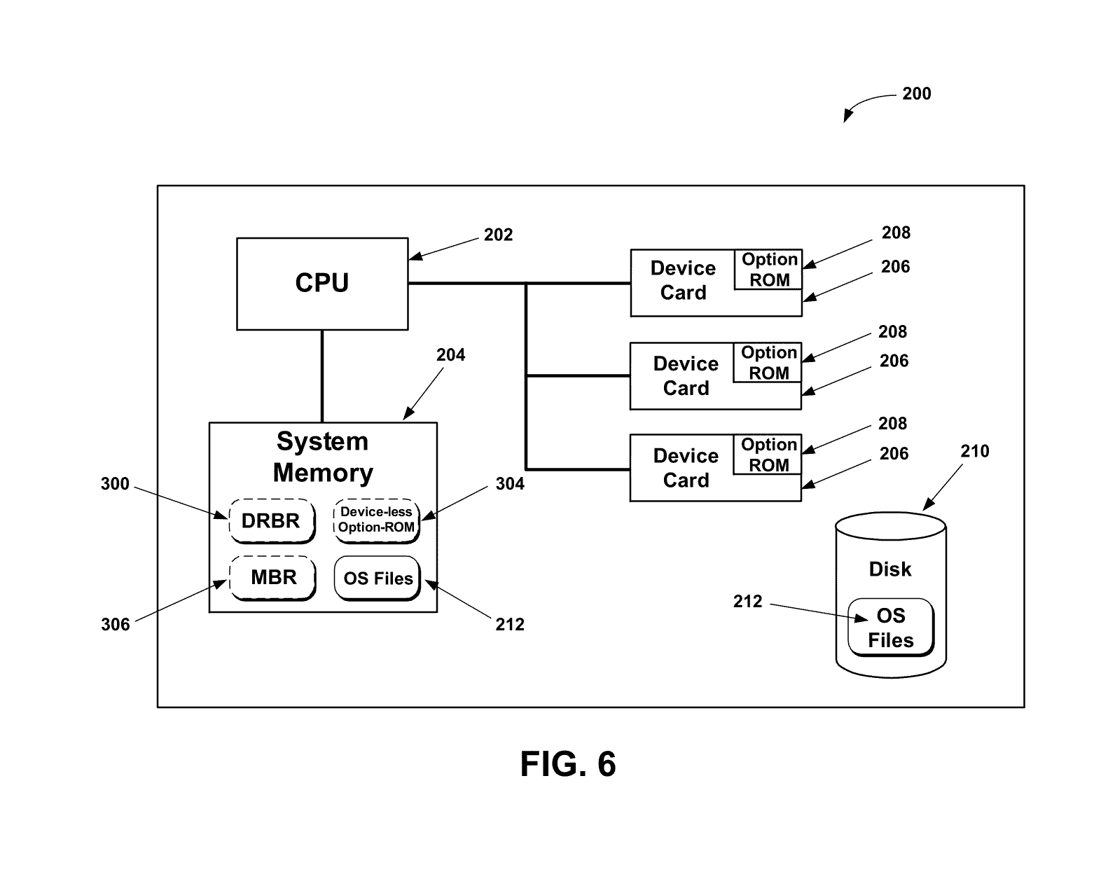

FIG. 6 is a block diagram showing the exemplary computer system 200 after loading the OS files 212 into system memory 204, in accordance with an embodiment of the present invention. As illustrated in FIG. 6, the DRBR 300, the device-less Option-ROM BIOS 304, MBR 306, and OS files 212 have been loaded into system memory 204 and the computer system 200 is now operating under the control of the OS. That is, the MBR 306 has facilitated loading of the OS files 212 into system memory 204 and the MBR 306 has transferred control to the OS. At this point, the remainder of the boot process can be completed as normal.

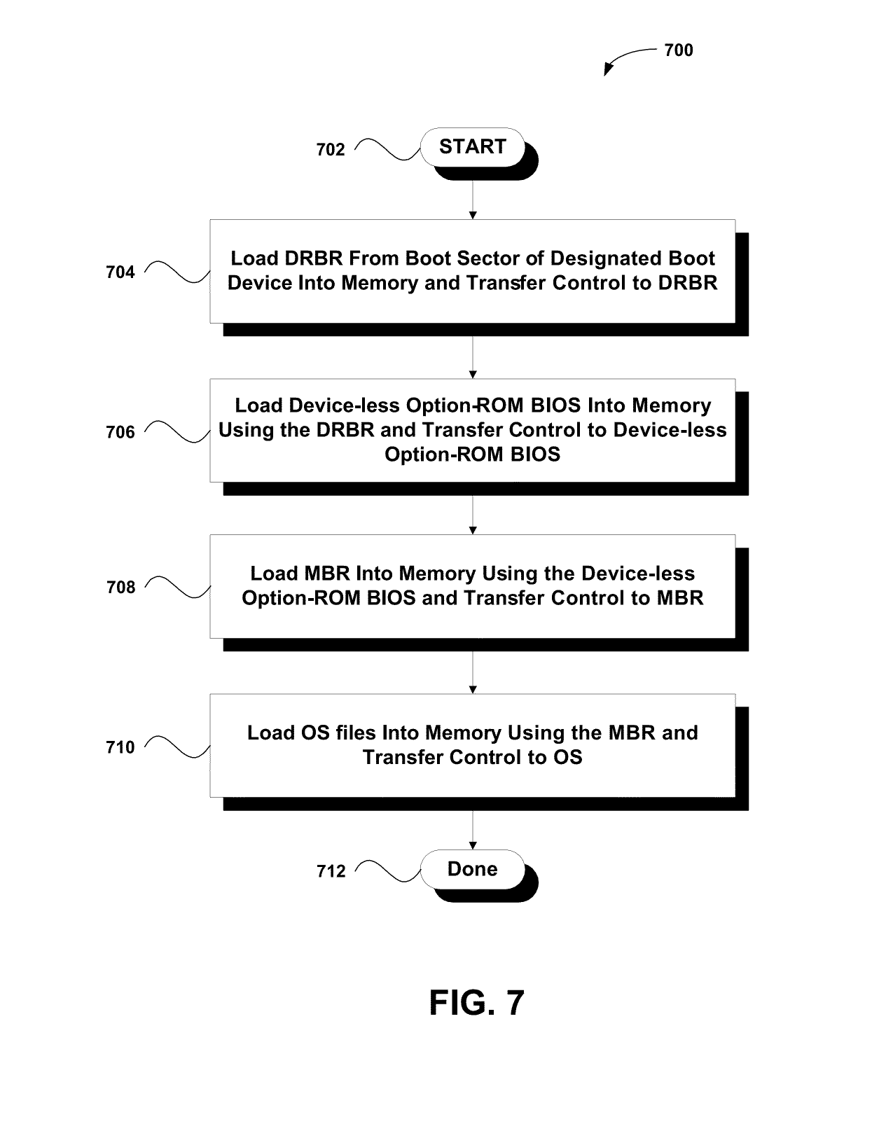

FIG. 7 is a flowchart showing a method 700 for loading an Option-ROM BIOS into memory without the need of an associated hardware device, such as a PCI card. In an initial operation 702, preprocess operations are performed. Preprocess operations can include, for example, loading a system BIOS into memory, detecting installed hardware device cards, and other preprocess operations that will be apparent to those skilled in the art after a careful reading of the present disclosure.

In operation 704, the DRBR is loaded from the boot sector of the designated boot device into system memory and control is transferred to the DRBR. As discussed previously, generally the first code executed by the CPU during system startup is the system BIOS. The system BIOS sets up the hardware for the computer system and loads the operating system, by scanning for installed hardware, such as device cards, and loading the Option-ROM BIOS for each device card into system memory.

The system BIOS then identifies a designated boot device, such as a boot disk, and attempts to load the OS software, which further controls the computer system. In prior art computer systems, the system BIOS loaded the MBR from the boot sector of the designated boot device, which was stored in sector 0, and consisted of machine code that once executed facilitated loading and execution of the OS files. However, as mentioned previously, embodiments of the present invention replace the MBR with a DRBR to facilitate loading of a device-less Option-ROM.

Next, the device-less Option-ROM BIOS is loaded into memory via the DRBR, and control is transferred to the device-less Option-ROM BIOS, in operation 706. As mentioned above, after loading the Option-ROM BIOS code from hardware installed on the computer system during startup, the system BIOS loads code from the boot sector. However, embodiments of the present invention replace the MBR normally stored at the boot sector with the DRBR to facilitate loading of a device-less Option-ROM. Thus, during startup the system BIOS loads the DRBR from the boot sector into system memory. The DRBR includes data, such as a pointer, denoting the location of the device-less Option-ROM BIOS stored on the designated boot device or other storage device. Hence, the DRBR functions to load the device-less Option-ROM BIOS into system memory. Then, once the device-less Option-ROM BIOS is loaded into system memory, the DRBR transfers control to it.

In operation 708, the MBR is loaded into memory via the device-less Option-ROM BIOS, and control is transferred to the MBR. Starting with operation 708, the process for loading the OS begins. The device-less Option-ROM BIOS includes data, such as a pointer, identifying the location of the MBR, which typically is stored on the designated boot device at a location other than the boot sector or on an alternate storage device (e.g., cache disk device). Once the device-less Option-ROM BIOS code has completed setting itself up and initializing, the device-less Option-ROM BIOS loads the MBR into system memory.

As note above, the MBR generally includes machine code that once executed facilitates loading and execution of the operating system files, before transferring control to the OS. The MBR can be similar to the master boot record of conventional computer systems. However, the MBR of the present invention is not stored in the boot sector (e.g., sector 0) of the designated boot device. Once the MBR is loaded and executed, the boot sequence can continue in much the same manner as in conventional computer systems.

In particular, as noted in operation 710, the MBR facilitates loading of the OS files into memory, and then transfers control to the OS. Once the OS is loaded, the remainder of system startup can follow normal startup lines. Post process operations are then performed in operation 712. Post process operations can include performing further system startup processes, handling IO requests via the operating system, and other post process operations that will be apparent to those skilled in the art after a careful reading of the present disclosure. Hence, embodiments of the present invention allow the device-less Option-ROM BIOS to operate as if it was loaded into memory from a PCI device. For example, the device-less Option-ROM BIOS can be utilized to filter pre-OS IO. Along these lines, when the OS is being loaded, the device-less Option-ROM BIOS of the embodiments of the invention can intercept some of the IO and serve the data from another device.

Advantageously, because the device-less Option-ROM BIOS is not associated with any particular hardware device, the device-less Option-ROM BIOS can interface with and handle multiple installed hardware devices. Conventional Option-ROMs can only interface with and handle the associated device card and the child devices of the device card. For example, the Option-ROM BIOS for a device card that has two disks connected to it can only control those two disks or the controller card. In contrast, the device-less Option-ROM BIOS of the embodiments of the present invention is not associated with any device card. As such, device-less Option-ROM BIOS can interface, handle and filter the IO for any disk or device card associated with the computer system.

In this manner, the device-less Option-ROM BIOS can facilitate disk caching in the pre-OS environment, before the operating system is loaded into system memory. Because the device-less Option-ROM BIOS is loaded and executed prior to loading the OS, the device-less Option-ROM BIOS can filter the IO associated with loading the OS into system memory. Thus, the device-less Option-ROM BIOS can intercept various IO requests and redirect specific request to a cache disk other than the designated boot device, allowing operating system files to be loaded from different disks.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for loading an Option-ROM BIOS into memory, comprising:
loading code from a boot sector of a designated boot device into memory, wherein the code includes Option-ROM location data denoting a location of an Option-ROM BIOS; and
loading the Option-ROM BIOS into memory utilizing the Option-ROM location data, wherein the Option-ROM BIOS includes MBR location data denoting a location of a master boot record (MBR) associated with an operating system (OS).

2. A method as recited in claim 1, further comprising loading the MBR into memory utilizing the MBR location data and transferring control to the MBR.

3. A method as recited in claim 2, further comprising loading OS system files into memory utilizing the MBR.

4. A method as recited in claim 1, wherein the code is stored in sector 0 of the designated boot device.

5. A method as recited in claim 1, wherein the Option-ROM BIOS filters input/output (IO) data in a pre-OS environment.

6. A method as recited in claim 5, wherein the Option-ROM BIOS redirects at least one file request to a storage device other than the designated boot device.

7. A method as recited in claim 1, further comprising:
copying an existing master boot record MBR to a new location on the designated boot device;
storing the code at the previous location of the MBR on the designated boot device; and
updating the Option-ROM BIOS to include MBR location data denoting the new location of the MBR on the designated boot device.

8. A method for loading an Option-ROM BIOS into memory, comprising:
loading code from a boot sector of a designated boot device into memory, wherein the code includes Option-ROM location data denoting a location of an Option-ROM BIOS;
loading the Option-ROM BIOS into memory utilizing the Option-ROM location data, wherein the Option-ROM BIOS includes MBR location data denoting a location of a master boot record (MBR) associated with an operating system (OS);
loading the MBR into memory utilizing the MBR location data and transferring control to the MBR; and
loading OS system files into memory utilizing the MBR.

9. A method as recited in claim 8, wherein the code is stored in sector 0 of the designated boot device.

10. A method as recited in claim 8, wherein the Option-ROM BIOS filters input/output (IO) data in a pre-OS environment.

11. A method as recited in claim 10, wherein the Option-ROM BIOS redirects at least one file request to a storage device other than the designated boot device.

12. A method as recited in claim 8, further comprising copying an existing master boot record MBR to a new location on the designated boot device.

13. A method as recited in claim 12, further comprising storing the code at the previous location of the MBR on the designated boot device.

14. A method as recited in claim 13, further comprising updating the Option-ROM BIOS to include MBR location data denoting the new location of the MBR on the designated boot device.

15. A computer program embodied on a computer readable medium for programming a computer to load an Option-ROM BIOS into memory, comprising:
a code segment for copying an existing master boot record (MBR) to a new location on the designated boot device;
a code segment for storing an Option-ROM BIOS on the designated boot device, wherein the Option-ROM BIOS includes MBR location data denoting a location of the MBR; and
a code segment for storing machine code at the previous location of the MBR on the designated boot device, the machine code including Option-ROM location data denoting the location of the Option-ROM BIOS,
wherein the machine code is loaded from the boot sector of a designated boot device into memory during system startup, and wherein the Option-ROM BIOS is loaded into memory utilizing the Option-ROM location data.

16. A computer program as recited in claim 15, wherein the MBR is loaded into memory utilizing the MBR location data during system startup.

17. A computer program as recited in claim 16, wherein the OS system files are loaded into memory utilizing the MBR during system startup.

18. A computer program as recited in claim 15, wherein the machine code is stored in sector 0 of the designated boot device.

19. A computer program as recited in claim 15, wherein the Option-ROM BIOS filters input/output (IO) data in a pre-OS environment.

20. A computer program as recited in claim 15, wherein the Option-ROM BIOS redirects at least one file request to a storage device other than the designated boot device.
